(19) United States
(12) Patent Application Publication
(10) Pub. No.: US 2021/0042606 A1
(43) Pub. Date: Feb. 11, 2021

(54) DEEP NEURAL NETWORK WITH EQUILIBRIUM SOLVER

(71) Applicants: Robert Bosch GmbH, Stuttgart (DE); Carnegie Mellon University, Pittsburgh, PA (US)

(72) Inventors: Shaojie BAI, Pittsburgh, PA (US); Jeremy Zieg KOLTER, Pittsburgh, PA (US); Michael SCHOBER, Tuebingen (DE)

(21) Appl. No.: 16/985,852

(22) Filed: Aug. 5, 2020

(30) Foreign Application Priority Data
Aug. 6, 2019 (EP) 19190237.8

(51) Int. Cl. G06N 3/04; G06N 3/08

(52) U.S. Cl. CPC G06N 3/0445; G06N 3/084

(57) ABSTRACT

Some embodiments are directed to a neural network comprising an iterative function (z^{[i+1]}=ƒ(z^{[i]}, θ, c(λ)). Such an iterative function is known in the field of machine learning to be representable by a stack of layers which have mutually shared weights. According to some embodiments the stack of layers may during training be replaced by the use of a numerical root-finding algorithm to find an equilibrium of the iterative function in which a further execution of the iterative function would not substantially further change the output of the iterative function. Effectively, the stack of layers may be replaced by a numerical equilibrium solver. The use of the numerical root-finding algorithm is demonstrated to greatly reduce the memory footprint during training while achieving similar accuracy as state-of-the-art prior art models.

### FIELD OF THE INVENTION

The invention relates to a system and computer-implemented method for training a neural network. The invention further relates to a trained neural network. The invention further relates to a system and computer-implemented method for using a trained neural network for inference, for example to control or monitor a physical system based on a state of the physical system which is inferred from sensor data. The invention further relates to a computer-readable medium comprising transitory or non-transitory data representing instructions for a processor system to perform either computer-implemented method.

### BACKGROUND OF THE INVENTION

Machine learned (‘trained’) models are widely used in many real-life applications, such as autonomous driving, robotics, manufacturing, building control, etc. For example, machine learnable models may be trained to infer a state of a physical system, such as an autonomous vehicle or a robot, etc., or the system's environment, e.g., the road on which the vehicle is travelling, the robot's workspace, etc., based on sensor data which is acquired by one or more sensors. Having inferred the state, the physical system may be controlled, e.g., using one or more actuators, or its operation may be monitored.

In many cases, neural networks with many layers (‘deep neural networks’) are the most successful models for a given task. However, the implementation of such deep neural networks typically requires a large amount of memory for parameters of the model, such as the weights per layer. In addition, the training itself of a deep neural network requires a large amount of memory, since in addition to the weights per layer, also a large amount of temporary data has to be stored for the forward passes (‘forward propagation’) and backward passes (‘backward propagation’) during the training. For example, the layer output of each individual layer (‘hidden state’) during forward propagation may need to be stored as temporary data as it may be used in the backward propagation. This way, the training of a deep neural network may require many gigabytes of memory, with the memory requirements being expected to further increase as the complexity of models increases. This may represent a serious bottleneck for training machine learnable models in the future, and may result in the training of machine learnable models on lower-spec (e.g., end-user) devices becoming infeasible due to the memory requirements. Such training on lower-spec devices may nevertheless be desired, for example for continual learning after deployment.

While it is known to share weights across some or all layers of a neural network, see, e.g., [1], thereby reducing the amount of data to be stored for the neural network's weights, the temporary data for the forward and backward passes typically still needs to be stored separately for each layer even if several layers have shared weights.

Another disadvantage, besides the large amount of data to be stored in memory, is that the propagating through all the layers of a deep neural network during training, but in some cases also during subsequent use, may be computationally complex and thereby time consuming, resulting in lengthy training sessions and/or a high latency of the model during use. The latter may be particularly undesirable in real-time use.

### REFERENCES

[1] Shaojie Bai, J. Zico Kolter, and Vladlen Koltun. Trellis networks for sequence modeling. In International Conference on Learning Representations (ICLR), 2019, https://arxiv.org/abs/1810.06682

### SUMMARY OF THE INVENTION

It would be desirable to obtain a neural network, and a training of the neural network, which addresses at least one of the disadvantages mentioned above.

In accordance with a first aspect of the invention, a computer-implemented method and corresponding system are provided for training a neural network, as defined by claims 1 and 15, respectively. In accordance with a further aspect of the invention, a computer-implemented method is provided for using the trained neural network for inference, as defined by claim 12. In accordance with a further aspect of the invention, a computer-readable medium is provided comprising transitory or non-transitory data representing model data defining a trained neural network, as defined by claim 14. In accordance with a further aspect of the invention, as defined by claim 12, a computer-readable medium is provided comprising instructions for causing a processor system to perform the computer-implemented method of any one of claims 1 to 12.

The above measures may involve providing a neural network which comprises an iterative function (z^{[i+1]}=ƒ(z^{[i]}, θ, c(x)). Such an iterative function is known in the field of machine learning to be representable by a stack of layers which have mutually shared weights. Namely, the iterative execution (also referred to as ‘iterative application’) of the individual layers of the stack of layers may establish the iterative function. In such a stack of layers, each layer except for the first layer may receive, as input, i) an output of the previous layer and ii) (a part of) an input to the stack of layers, being either the original input (x) to the neural network or a transformation of that input (c(x)), for example by one or more previous layers preceding the stack of layers in the neural network. The latter may also be referred to as a ‘passthrough’ from the input of the stack of layers to each individual layer, or as a ‘skip connection’ or ‘direct injection’ of this input. The first layer of the stack of layers may receive an initial activation as input, which may for example be an output of yet another layer of the neural network. By having mutually shared weights, such layers provide the same transformation in each layer (also known as ‘weight-tying’). Accordingly, the stack of layers may be executed by iteratively executing a same layer. In other words, a stack of weight-tied layers having depth L may be replaced, in the neural network and/or its training, by an iterative L-times execution of a same layer, and vice versa. Since both concepts (‘iterative execution of same layer’, ‘execution of stack of layers’) are functionally equivalent, a reference to one concept also includes the other concept, unless otherwise noted.

While weight-tying imposes the limitation that the weights for each individual layer of the stack of layers are the same, it is nevertheless known to achieve results competitive with the state-of-the-art. Neural networks may entirely consist of such weight-tied layers but may in other embodiments also comprise a stack of such layers amongst other types of layers. Reference [1] uses such weight-tying in its neural network.

As described in the background section, during training, the iterative execution of a stack of layers still requires a sizable memory footprint, since the layer output of each individual layer (even if weight-tied) during forward propagation may need to be stored as temporary data as it may be used in the subsequent backward propagation.

The measures described in this specification replace, during training but in some embodiments also during subsequent use, the iterative execution of a same layer by the use of a numerical root-finding algorithm. Namely, the inventors have considered that the iterative execution of the same layer may result in a convergence to a fixed point after a certain number of executions, which may here and in the following also be referred to as an equilibrium point (z*), representing an equilibrium of the stack of layers (or iterative function) in which each following layer (or a further execution of the iterative function) would not substantially further change the output of the stack of layers (or of the iterative function). In other words, there may exist an equilibrium point which, when used as input to the iterative function (z*=ƒ(z*, θ, c(x)), is again provided as output of the iterative function. Such an equilibrium point may also be considered as a convergence point of the iterative function.

Instead of simply providing a stack of layers having a certain depth (i.e., executing a same layer a certain amount of times), the measures described in this specification numerically determine the equilibrium point and provide the equilibrium point as a substitute output of the stack of layers, thereby effectively replacing the iterative execution of a same layer by the use of the root-finding algorithm. Indeed, the equilibrium point may be determined numerically since it is known that at such an equilibrium point, the iterative function ƒ(z*, θ, c(x)) minus its input (z*) is zero. Accordingly, a numerical root-finding algorithm may be used to find the root solution of the iterative function minus its input. For example, a root-finding algorithm may be used which is based on a computer-implementation of Newton's methods or a quasi-Newton method such as Broyden's method.

The numerical calculation of the equilibrium point may thereby be provided as a substitute to a stack of weight-tied layers, in that it may functionally correspond to such a stack of weight-tied layers but may be structurally different therefrom. As demonstrated in this specification, the replacement of the iterative application of a same layer by a numerical root-finding approach is feasible and has been found to greatly reduce the memory footprint during training while achieving similar accuracy as state-of-the-art prior art models. Thereby, the training of the neural network using the numerical root-finding approach is less memory intensive, or allows the training of deeper neural networks using a same memory footprint. Namely, the memory requirement of the root-finding algorithm is independent of the iteration depth (depth of the stack of layers). Advantageously, using the above measures, the training of machine learnable models on lower-spec (e.g., end-user) devices having limited memory may be facilitated, for example for enabling continual learning of a neural network even after deployment of the neural network. The numerical root-finding algorithm may be used as a substitute in the training of any neural network architecture, e.g., forward networks or recurrent networks, to replace a stack of weigh-tied layers. In some cases, applying a root-finding algorithm may be computationally faster than iterative layer application.

It is noted that in the above and elsewhere, the term ‘equilibrium point’ and ‘fixed point’ include the point being an array or a vector of values. In addition, the root-finding algorithm may obtain an approximation of the equilibrium point, e.g., to a select degree. The ‘select degree’ may represent a convergence criterion, which may be predefined. The term ‘determining the equilibrium point’ thus includes determining an approximation thereof.

Optionally, the numerical root-finding algorithm is a computer-implementation of Newton's method or a computer-implementation of a quasi-Newton method or specifically a computer-implementation of Broyden's method. Any numerical root-finding algorithm may in principle be used, including Newton's method-based algorithms. However, the inventors have found that Broyden's method may be particularly efficient since it may avoid the computation of the exact inverse Jacobian at every intermediate Newton iteration.

Optionally, performing the backward propagation part comprises:
computing respective partial derivatives of the iterative function

$$( \frac{df ( {z}^{*} , θ , c ( x ) )}{d θ} , \frac{df ( {z}^{*} , θ , c ( x ) )}{d c ( x )} )$$

with respect to the weights (θ) and the part of the input (c(x));
computing a gradient (δₑ, δ_{c}) at an input of the iterative execution layer for the weights (θ) and/or the part of the input (c) as a function of a respective partial derivative and a backpropagated gradient (δ_{z}) at the output of the iterative execution layer.

The derivatives which are indicated above may be implemented via their analytic equations or computed, e.g., via automatic differentiation tools. Accordingly, the back propagation may be performed without having to store intermediate layer outputs in memory, which would otherwise be necessary for back propagation in deep neural networks.

Optionally, computing the gradient (δₑ, δ_{c}) comprises solving a linear system ((J₉|_{z*})^{T}x=−δ_{z}^{T}) and computing the gradient as a function of a solution of the linear system

$$( {δ}_{θ} = {x}^{T} \frac{d f ( {z}^{*} , θ , c ( x ) )}{d θ} , {δ}_{c} = {x}^{T} \frac{d f ( {z}^{*} θ c ( x ) )}{d c ( x )} ) .$$

The inventors have found that the backpropagation of the backward gradient through the stack of layers may be replaced by solving the above linear system which may involve using one step of matrix multiplications that involves the Jacobian at equilibrium. Herein, the vector-Jacobian product may be efficiently computed via automatic differentiation tools for any x, without having to explicitly write out the Jacobian matrix. This may be a particularly efficient way of performing the backward propagation during training.

Optionally, solving the linear system comprises using a fast matrix vector multiplication technique. Optionally, solving the linear system comprises using an instance of the numerical root-finding algorithm or another type of numerical root-finding algorithm. For example, Broyden's method may be used to solve the linear system ((J_{g}|_{z*})^{T}x+δ_{z}^{T}=0).

Optionally, outputting the trained neural network comprises representing the stack of layers in the trained neural network by at least i) a data representation of a layer (z^{[i+1]}=ƒ(z^{[i]}, θ, c(x)) of the stack of layers, and ii) a hyperparameter defining a number of layers of the stack of layers (z^{[i]}, i=0, 1, 2, . . . , L) at which the output of the stack of layers reaches or to a selected degree approximates the equilibrium point during forward propagation. Accordingly, the trained neural network may be output in a prior art manner, namely by defining the stack of layers and its weights and the depth of the stack of layers. The depth may be chosen as a hyperparameter so that during use of the trained neural network, the equilibrium point is reached or at least approximated to a sufficient degree.

Optionally, outputting the trained neural network comprises representing the stack of layers in the trained neural network by at least i) the mutually shared weights (θ), ii) an identifier or a data-representation of the numerical root-finding algorithm, and iii) one or more parameters for using the numerical root-finding algorithm to determine the equilibrium point. Instead of representing the iterative function by a stack of layers, the iterative function may be represented by the mutually shared weights found during training and by data which allows the equilibrium point to be determined during inference. Such data may take various forms. For example, the numerical root-finding algorithm itself may be included, e.g., as computer-readable instructions, or an identifier of the algorithm which allows the entity using the trained neural network for inference to identify the numerical root-finding algorithm to be used. In addition, parameters may be included so as to allow the entity using the trained neural network for inference to determine the equilibrium point during the forward pass. This represents an alternative to the iterative application of the same layer during inference, and may provide a higher accuracy (for example, if it is computationally infeasible to execute the same layer to a sufficiently high degree) and may in some cases be faster to compute. The latter may reduce the latency of the model during inference, and may be advantageous in applications in which a low latency is desirable, such as for example autonomous driving.

Optionally, outputting the trained neural network comprises representing the stack of layers in the trained neural network by at least i) a data representation of a layer (z^{[i+1]}=ƒ(z^{[i]}, θ, c(x)) of the stack of layers, and ii) computer-readable instructions defining a convergence check for determining when an output obtained by an iterative execution of the layer reaches or to a selected degree approximates the equilibrium point. This represents yet another alternative to representing the iterative function by a stack of layers. Namely, the trained neural network may define one layer of the stack of layers but may additionally comprise computer-readable instructions which define a convergence check and which allow an entity using the trained neural network for inference to determine when an output obtained by an iterative execution of the layer reaches or to a selected degree approximates the equilibrium point. Accordingly, it may be ensured that the equilibrium point is approximated to a sufficient degree while avoiding unnecessary layer executions at runtime.

Optionally, the neural network is a feedforward neural network or a recurrent neural network. In general, the root-finding algorithm may be used in any neural network architecture to replace an iterative function represented by a stack of weight-tied layers.

Optionally, the training data is time-sequential data, and wherein the neural network is one of a group of: a Trellis network, a transformer network and a temporal convolution network. While the application to time-sequential data has been found to be advantageous, the applicability of the measures described in this specification is not limited to such type of data, but may also be used with other types of data, such as spatial data.

It will be appreciated by those skilled in the art that two or more of the above-mentioned embodiments, implementations, and/or optional aspects of the invention may be combined in any way deemed useful.

Modifications and variations of any system, any computer-implemented method or any computer-readable medium, which correspond to the described modifications and variations of another one of said entities, can be carried out by a person skilled in the art on the basis of the present description.

### BRIEF DESCRIPTION OF THE DRAWINGS

These and other aspects of the invention will be apparent from and elucidated further with reference to the embodiments described by way of example in the following description and with reference to the accompanying drawings, in which

FIG. 1 shows a system for training a neural network in which a substitute is provided for a stack of layers which defines an iterative function, and wherein the system is configured to determine an equilibrium point at which the iterative function converges and to provide the equilibrium point as a substitute for the output of the stack of layers;

FIG. 2 shows a computer-implemented method for training a neural network;

FIG. 3 illustrates a solving for an equilibrium point in 2D;

FIG. 4A shows a deep neural network with a stack of layers having mutually shared weights and together defining an iterative function;

FIG. 4B shows a deep neural network in which the output of a stack of layers is substituted by the output of an equilibrium solver applied to the iterative function;

FIG. 5 shows a graph setting out the number of Broyden iterations of a deep-equilibrium model (DEQ)-based transformer against the training epoch;

FIG. 6 shows a graph setting out the number of function evaluations against a difference norm for the DEQ-transformer and a weight-tied transformer as reference;

FIG. 7 shows system for applying the trained neural network to input data;

FIG. 8 shows the system as part of an (semi-)autonomous vehicle;

FIG. 9 shows a computer-implemented method for using a trained neural network for inference, for example to control a physical system; and

FIG. 10 shows a computer-readable medium comprising data.

It should be noted that the figures are purely diagrammatic and not drawn to scale. In the figures, elements which correspond to elements already described may have the same reference numerals.

### LIST OF REFERENCE NUMBERS

The following list of reference numbers is provided for facilitating the interpretation of the drawings and shall not be construed as limiting the claims.
20 sensor
22 camera
40 actuator
42 electric motor
60 environment
80 (semi)autonomous vehicle
100 system for training neural network
160 processor subsystem
180 data storage interface
190 data storage
192 training data
194 data representation of untrained neural network
196 data representation of trained neural network
200 method for training neural network
210 providing data representation of neural network
220 accessing training data
230 iteratively training neural network using training data
240 determining equilibrium point using root-finding algorithm
250 providing equilibrium point as substitute for output of stack of layers
260 outputting trained neural network
300 illustration of solving for equilibrium point in 2D
310 deep neural network with equilibrium solver
320 weight-tied deep neural network
330 numerical root-finding step
340 iterative function minus its input
350 equilibrium point
400 deep neural network
410 deep neural network with equilibrium solver
420 neural network depth
430 forward propagation direction
440 backward propagation direction
450 history (or zero) padding
460 input injection, positional embedding
470 memory storage needed at training time for backward pass
480 equilibrium solver
500 illustration of number of Broyden iterations of DEQ-transformer
510 training epochs
520 number of Broyden iterations per time step
530 forward propagation
540 backward propagation
600 illustration of finding of equilibrium of DEQ-transfomer
610 number of function evaluations
620 difference norm
630 weight-tied transformer (epoch 1)
640 weight-tied transformer (epoch 12)
650 DEQ-transformer (epoch 1)
660 DEQ-transformer (epoch 12)
700 system for control or monitoring using learned dynamics model
720 sensor data interface
722 sensor data
740 actuator interface
742 control data
760 processor subsystem
780 data storage interface
790 data storage
800 method for using trained neural network
810 accessing trained neural network
820 accessing input data
830 applying trained neural network to input data
840 determining equilibrium point
850 providing equilibrium point as substitute for output of stack of layers
900 computer-readable medium
910 non-transitory data

### DETAILED DESCRIPTION OF EMBODIMENTS

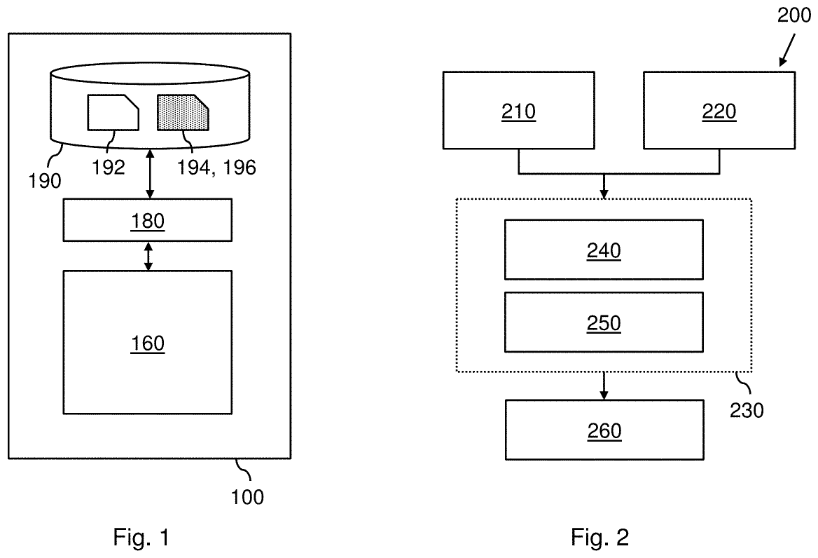

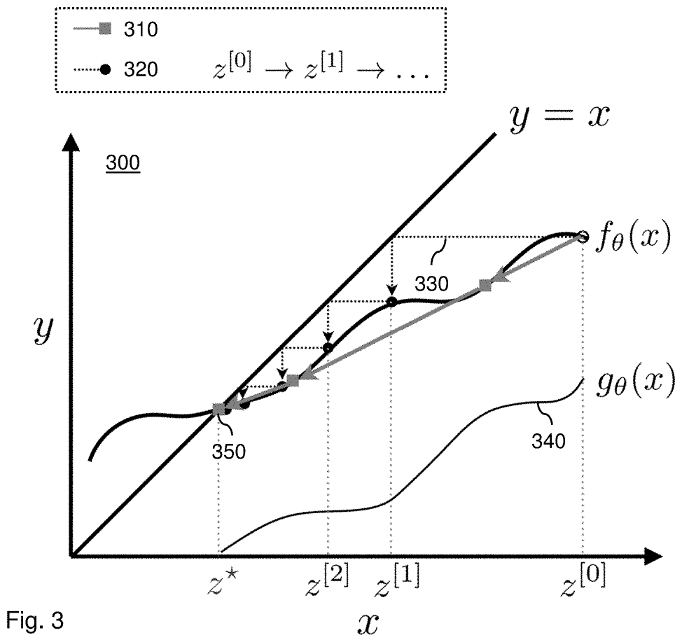

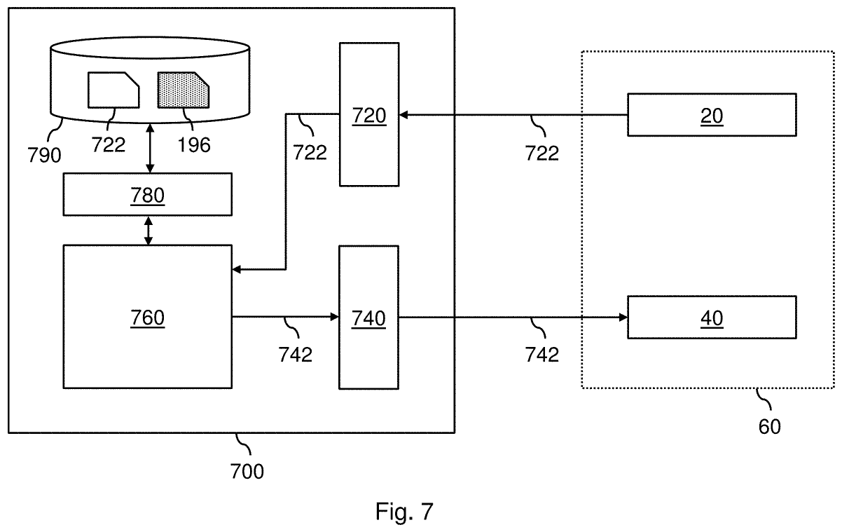

The following describes with reference to FIGS. 1 and 2 the training of a neural network which uses a substitute for a stack of layers of the neural network having mutually shared weights, then describes with reference to FIGS. 3-6 the neural network and its training in more detail, and with reference to FIGS. 7-9 the use of the trained neural network for the control or monitoring of a physical system, such as an (semi-)autonomous vehicle.

FIG. 1 shows a system 100 for training a neural network. The system 100 may comprise an input interface for accessing training data 192 for the neural network. For example, as illustrated in FIG. 1, the input interface may be constituted by a data storage interface 180 which may access the training data 192 from a data storage 190. For example, the data storage interface 180 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 190 may be an internal data storage of the system 100, such as a hard drive or SSD, but also an external data storage, e.g., a network-accessible data storage.

In some embodiments, the data storage 190 may further comprise a data representation 194 of an untrained version of the neural network which may be accessed by the system 100 from the data storage 190. It will be appreciated, however, that the training data 192 and the data representation 194 of the untrained neural network may also each be accessed from a different data storage, e.g., via a different subsystem of the data storage interface 180. Each subsystem may be of a type as is described above for the data storage interface 180. In other embodiments, the data representation 194 of the untrained neural network may be internally generated by the system 100 on the basis of design parameters for the neural network, and therefore may not explicitly be stored on the data storage 190.

The system 100 may further comprise a processor subsystem 160 which may be configured to, during operation of the system 100, provide an iterative function as a substitute for a stack of layers of the neural network to be trained. Here, respective layers of the stack of layers being substituted may have mutually shared weights and may receive as input an output of a previous layer, or for a first layer of the stack of layers, an initial activation, and a part of the input of the stack of layers. The processor subsystem 160 may be further configured to iteratively train the neural network using the training data 192. Here, an iteration of the training by the processor subsystem 160 may comprise a forward propagation part and a backward propagation part. The processor subsystem 160 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network. It is noted that the neural network and its training will be further described with reference to FIGS. 3-6.

The system 100 may further comprise an output interface for outputting a data representation 196 of the trained neural network, this data also being referred to as trained model data 196. For example, as also illustrated in FIG. 1, the output interface may be constituted by the data storage interface 180, with said interface being in these embodiments an input/output (‘IO’) interface, via which the trained model data 196 may be stored in the data storage 190. For example, the data representation 194 defining the ‘untrained’ neural network may during or after the training be replaced, at least in part, by the data representation 196 of the trained neural network, in that the parameters of the neural network, such as weights, hyperparameters and other types of parameters of neural networks, may be adapted to reflect the training on the training data 192. This is also illustrated in FIG. 1 by the reference numerals 194, 196 referring to the same data record on the data storage 190. In other embodiments, the data representation 196 may be stored separately from the data representation 194 defining the ‘untrained’ neural network. In some embodiments, the output interface may be separate from the data storage interface 180, but may in general be of a type as described above for the data storage interface 180.

FIG. 2 shows a computer-implemented method 200 for training a neural network. The method 200 may correspond to an operation of the system 100 of FIG. 1, but does not need to, in that it may also correspond to an operation of another type of system, apparatus or device or in that it may correspond to a computer program.

The method 200 is shown to comprise, in a step titled “PROVIDING DATA REPRESENTATION OF NEURAL NETWORK”, providing 210 a neural network, wherein the providing of the neural network comprises providing an iterative function as a substitute for a stack of layers of the neural network, wherein respective layers of the stack of layers being substituted have mutually shared weights and receive as input an output of a previous layer, or for a first layer of the stack of layers, an initial activation, and a part of the input of the stack of layers. The method 200 is further shown to comprise, in a step titled “ACCESSING TRAINING DATA”, accessing 220 training data for the neural network. The method 200 is further shown to comprise, in a step titled “ITERATIVELY TRAINING NEURAL NETWORK USING TRAINING DATA”, iteratively 230 training the neural network using the training data, which training 230 may comprise a forward propagation part and a backward propagation part. Performing the forward propagation part by the method 200 may comprise, in a step titled “DETERMINING EQUILIBRIUM POINT USING ROOT-FINDING ALGORITHM”, determining 240 an equilibrium point of the iterative function at which the iterative function converges to a fixed point, wherein determining the equilibrium point comprises using a numerical root-finding algorithm to find a root solution for the iterative function minus its input, and in a step titled “PROVIDING EQUILIBRIUM POINT AS SUBSTITUTE FOR OUTPUT OF STACK OF LAYERS”, providing 250 the equilibrium point as a substitute for an output of the stack of layers in the neural network. The method 200 may further comprise, after the training and in a step titled “OUTPUTTING TRAINED NEURAL NETWORK”, outputting 260 a trained neural network.

The following examples describe the neural network, including the training thereof in which a stack of layers is substituted by an iterative function and in which a root-finding algorithm is used to determine an equilibrium point at which the iterative function converges to a fixed point, in more detail. However, the actual implementation of the neural network and its training may be carried out in various other ways, e.g., on the basis of analogous mathematical concepts. For example, while the following describes both the forward passes and the backward passes being based on a numerical root-finding algorithm, in some embodiments, only the forward pass may be as described below while the backward pass may be performed in another manner, e.g., by backpropagation of algebra terms which are used in the root-finding algorithm so as to obtain a backpropagated algebraic expression. In other examples, Boyden's method may be replaced by a use of the so-called ‘Anderson acceleration’ technique to accelerate the convergence of a fixed point iteration and thereby to determine the equilibrium point of the iterative function. Various other embodiments are within reach of the skilled person based on this specification.

The following considers a deep neural network with hidden layers z and activations ƒ such that z^{[i+1]}=ƒ(z^{[i]}, θᵢ, c(x)) for i=0, 1, 2, . . . , L with weights θᵢ and previous layer inputs c(x) may both be tied across layers, i.e., θᵢ=θ∀i. Some of the activations ƒ may exhibit an attractor property, in that there may exist a fixed point z* such that z*=ƒ(z*, θ, c(x)) and

$${lim}_{L -> ∞} \underbrace{( f o … o f )}_{L - times} ( {z}^{[ 0 ]} , θ , c ( x ) ) = {z}^{*} .$$

In other words, the repeated application of ƒ for an initial activation z^{[0]} may converge to a fixed point z*. The following describes replacing the iterated function application or the iterated function execution by the use of a numerical method, namely a numerical root-finding algorithm, to find the fixed point directly.

The forward pass, which may also be referred to as a forward propagation part of the training or simply as ‘inference’, may be briefly characterized as follows:

Input: weights θ∈Rⁿ and fixed input c(x)∈R^{k}

Hyperparameters: base layer function ƒ: R^{m}×Rⁿ×R^{k}→R^{m}

Algorithm:

1. Initialize memory z^{[0]}.

2. Define function g: z [symbol] ƒ(z, θ, c)−z.

3. Call subroutine z*=RootFind(λz [symbol] g(z),z^{[0]}).

Output: z*∈R^{m}

RootFind may be computed via any Newton's method variant, e.g, classic Newton-Raphson method, Broyden's method, Steffensen's method, etc.

The backward pass, which may also be referred to as a backward propagation part or simply as ‘training’, may be briefly characterized as follows:

Input: Backpropagated error δ_{z}∈R^{m} as well as z*∈R^{m}, c(x)∈R^{k}, weights θ∈Rⁿ and base layer function ƒ: R^{m}×Rⁿ×R^{k}→R^{m} from the forward pass.

$$\begin{matrix} Algorithm : & \\ Define function g : z ↦ f ( z , θ , c ( x ) ) - z . & 1 \\ Compute partial derivatives \frac{df ( {z}^{*} , θ , c ( x )}{d θ} and \frac{df ( {z}^{*} , θ , c ( x ) ) )}{d c ( x )} .. & 2 \\ A ) Compute {δ}_{θ} = - {{δ}_{z} ( {J}_{g} {\vert}_{{z}^{*}} )}^{- 1} \frac{df ( {z}^{*} , θ , c ( x ) )}{d θ} and {δ}_{c} = - {{δ}_{z} ( {J}_{g} {\vert}_{{z}^{*}} )}^{- 1} \frac{df ( {z}^{*} , θ , c ( x ) )}{d c ( x )} . \\ Or \\ B ) Solve linear system {( {J}_{g} {\vert}_{{z}^{*}} )}^{T} x = - {δ}_{z}^{T} via suitable subroutine . \\ Compute {δ}_{θ} = {x}^{T} \frac{df ( {z}^{*} , θ , c ( x ) )}{d θ} and {δ}_{c} = {x}^{T} \frac{df ( {z}^{*} , θ , c ( x ) )}{d c ( x )} . \\ Output \text{:} {δ}_{θ} ∈ {R}^{n} , {δ}_{c} ∈ {R}^{k} . & 3\end{matrix}$$

If (J_{g}|_{z*})⁻¹ or an approximation thereof has been already computed in the forward pass in RootFind, (J_{g}|_{z*})⁻¹ or its approximation may be stored during the forward pass and used in the backward pass. For solving the linear system, any suitable method may be used, for example an indirect method that exploits fast matrix-vector products.

Broyden's method may be used in solving the linear system, as well as any other Newton's method variant. In general, all derivatives which are indicated above may be implemented via their analytic equations or computed, e.g., via automatic differentiation tools.

The following further describes the above measures within the context of the modeling of sequential data, i.e., x_{1:T}. It will be appreciated, however, that the applicability is not limited to sequential data, but may be applied to spatial or any other type of data x as well. It is further noted that the following replaces c(x), referring to the initial input of the stack of layers which is used as a constant input to each individual layer, by the equivalent x.

As an introductory comment, it is noted that most modern feedforward deep neural networks (in the following also simply referred to as ‘networks’ or ‘nets’ or ‘models’) are built on the core concept of layers. In the forward pass, each network may consist of a stack of some L transformations, where L is the depth of the network. To update these networks, the backward passes may rely on backpropagating through the same L layers via the chain rule, which typically necessitates that the intermediate values of these layers are stored as temporary data. The value for L is usually a hyperparameter and is selected by model designers (e.g., ResNet-101). Among the many applications of deep networks, sequence modelling has witnessed continuous advances in deep architectures. Specifically, while recurrent networks have long been the dominant model for sequences, deep feedforward architectures based on temporal convolutions and self-attention have (re-) emerged to claim superior performance on a variety of sequence prediction tasks.

In very general terms, a deep feedforward sequence model may be written as the following iteration:

z_{1:T}^{[i+1]}=ƒ_{θ}^{[i]}(z_{1:T}^{[i]},x_{1:T}) for i=0,1,2, . . . ,L (1)

where i is the layer index; is the hidden sequence of length T at layer i; x_{1:T} is the input sequence and thereby the model explicitly models skip connections for reasons as explained later; and ƒ_{θ}^{[i]} is some nonlinear transformation which may typically enforce causality (e.g., future time points cannot influence past ones). The following is based on the use of the same transformation in each layer (known as weight tying, with ƒ_{θ}^{[i]}=ƒ_{θ},∀i) which is known to still achieve results competitive with the state-of-the-art.

The following further introduces a method that directly computes the fixed point z_{1:T}* of a nonlinear transformation, e.g., the solution to the nonlinear system

z_{1:T}*=ƒ_{θ}(z_{1:T}*x_{1:T}). (2)

This solution corresponds to the eventual hidden layer values of an infinite depth network. But instead of finding this value, which may be an array or a vector of values and which here and elsewhere be referred to as ‘equilibrium point’, by iterating the model, the equilibrium point may be found directly via any black-box root-finding method. This approach may be referred to as a deep equilibrium model (DEQ) approach or simply ‘DEQ’.

The following shows that DEQ may directly differentiate through the fixed point equations via implicit differentiation, which may not require storing any intermediate activation values. In other words, one may backpropagate through the infinite-depth network while using only constant memory, equivalent to a single layer's activations. After describing the generic DEQ approach, the instantiation of DEQ is described in two feedforward sequence models: trellis networks (weight-tied temporal convolutions) and memory-augmented universal transformers (weight-tied multi-head self-attention), both of which have obtained state-of-the-art performance on various sequence tasks. It is further shown how both the forward and the backward passes may be implemented via quasi-Newton methods.

One may broadly consider the class of weight-tied deep sequence models (with passthrough connections from the input to each layer), which consist of the update

z_{1:T}^{[i+1]}=ƒ_{θ}(z_{1:T}^{[i]},x_{1:T}), i=1 . . . . ,L−1, z_{1:T}^{[0]}=0 (3)

It is noted that this model encapsulates classes such as the trellis network and the universal transformer (which is typically not written with passthrough connections, but this is a trivial modification). Such weight-tying is generally considered to come with three major benefits: 1) it acts as a form of regularization that stabilizes training and supports generalization; 2) it significantly reduces the model size; and 3) the network can be unrolled to any depth, typically with improved feature abstractions as depth increases. However, in practice almost all such models (and deep networks in general) may be stacked, trained and evaluated by unrolling a pre-determined, fixed number of layers. One critical issue contributing to this is the limited memory on training hardware: as the models may need to store the intermediate hidden units for backpropagation, one may hardly train them beyond a certain depth, which depth may in turn depend on the computing resources available.

In principle, the network may have an infinite depth. This is attained in the limit of unrolling a weight-tied network for a higher and higher number of layers. However, such weight-tied models tend to converge to a fixed point as depth increases towards infinity, which has been determined via empirical evidence. In other words, as each layer refines the previous layer by combining temporal features across the sequence, increasing depth towards infinity brings “diminishing returns”: each additional layer may have a smaller and smaller contribution until the network reaches an equilibrium state:

$${lim}_{i \to ∞} {z}_{1 : T}^{[ i ]} = {lim}_{i \to ∞} {f}_{θ} ( {z}_{1 : T}^{[ i . ]} ; {x}_{1 . T} ) ≡ {f}_{θ} ( {z}_{1 : T}^{⋆} ; {x}_{1 : T} ) = {z}_{1 : T}^{⋆} \qquad ( 4 )$$

The DEQ approach may comprise, instead of iteratively stacking ƒ_{θ}, directly solving for and differentiating through the equilibrium state.

The following discusses the forward pass of the training, and which also may be used for inference using the trained neural network. Unlike a conventional network where the output is just the L^{th} layer activations, the output of a DEQ is the equilibrium point itself. Therefore, the forward evaluation could be any procedure that solves for this equilibrium point. Conventional deep sequence networks, if they converge to an equilibrium, may be considered as one such method that uses the simplest fixed point iterations:

z_{1:T}^{[i+1]=ƒ}_{θ}(z_{1:T}^{[i]};x_{1:T}) for i=0,1,2, . . . (5)

One may alternatively also use other methods that provide faster convergence guarantees. For notational convenience, one may define g_{θ} and re-write Eq. ((4)) as: g_{θ}(z_{1:T}*;x_{1:T})=ƒ_{θ}(z_{1:T}*;x_{1:T})−z_{1:T}*→0. The equilibrium state z_{1:T}* may thus be the root of g_{θ}, which may be solved more easily with Newton's method or quasi-Newton methods (e.g., Broyden's method):

z_{1:T}^{[i+1]}=z_{1:T}^{[i]}−αBg_{θ}(z_{1:T}^{[i]};x_{1:T}) for i=0,1,2, . . . (6)

where B is the Jacobian inverse (or its low-rank approximation) at z_{1:T}^{[i]} and α is the step size. However, in general, any ‘black-box’ type of numerical root-finding algorithm may be used to solve for the equilibrium point in the forward pass, given an initial estimate) z_{1:T}^{[0]} (which may be set to 0): z_{1:T}*=RootFind(g_{θ};x_{1:T})

The following discusses the backward pass of the training. The use of a black-box RootFind may mean that one may no longer be able to rely on explicit backpropagation through the exact operations in the forward pass. However, one may adapt the numerical root-finding algorithm (say Newton's method) to obtain the equilibrium, and then store and allow backpropagating through all the Newton iterations, the following describes an alternative procedure which may be simpler to implement and which may require constant memory and assume no knowledge of the black-box RootFind.

Let z_{1:T}*∈ [symbol] ^{T×d} be an equilibrium hidden sequence with length T and dimensionality d, and y_{1:T}∈ [symbol] ^{T×q} the ground-truth (target) sequence. Let h: [symbol] ^{d}→ [symbol] ^{q} be any differentiable function and let [symbol] : [symbol] ^{q}× [symbol] ^{q}→ [symbol] be a loss function (where h, [symbol] are applied in vectorized manner) that computes

[symbol]

= [symbol] (h(z_{1:T}*),y_{1:T})= [symbol] (h(RootFind(g_{θ};x_{1:T})),y_{1:T}). (7)

Then the loss gradient w.r.t. (⋅) (for instance, θ or x_{1:T}) is:

$$\frac{\partial 𝓁}{\partial ( . )} = - \frac{\partial 𝓁}{\partial {z}_{1 : T}^{*}} ( {J}_{{g}_{θ}}^{- 1} {\vert}_{{z}_{1 : t}^{*}} ) \frac{{df}_{θ} ( {z}_{1 : T}^{*} ; {x}_{1 : T} )}{d ( . )} = - \frac{\partial 𝓁}{\partial h} \frac{\partial h}{\partial {z}_{1 : T}^{*}} ( {J}_{{g}_{θ}}^{- 1} {\vert}_{{z}_{1 : T}^{*}} ) \frac{{df}_{θ} ( {z}_{1 : T}^{*} ; {x}_{1 : T} )}{d ( . )} \qquad ( 8 )$$

where J_{g}_{_{θ}}⁻¹|ₓ means the inverse Jacobian of g_{θ} evaluated at x.

It has been found that the backward gradient through the “infinite” stacking may be represented as one step of matrix multiplication that involves the Jacobian at equilibrium. For instance, a stochastic gradient descent (SGD) update step on model parameters θ may be expressed as:

$${θ}^{+} = θ - α \cdot \frac{\partial 𝓁}{\partial θ} = θ + α \frac{\partial 𝓁}{\partial {z}_{1 : T}^{⋆}} ( {J}_{{g}_{θ}}^{- 1} {\vert}_{{z}_{1 : T}^{⋆}} ) \frac{d {f}_{θ} ( {z}_{1 : T}^{⋆} ; {x}_{1 : T} )}{d θ} \qquad ( 9 )$$

Note that this result may be independent of the root-finding algorithm or the internal structure of the transformation ƒ_{θ}, and thus may not require any storage of the intermediate hidden states, which would otherwise be needed for deep backpropagation.

A challenge of enforcing the forward and backward passes described above may be the cost of computing the exact inverse Jacobian J_{g}_{_{θ}}⁻¹ at every intermediate Newton iteration. This may be addressed by using Broyden's method, a quasi-Newton approach that makes low-rank updates to approximate J_{g}_{_{θ}}⁻¹ via the Sherman-Morrison formula:

$${J}_{{g}_{θ}}^{- 1} {\vert}_{{z}_{1 : T}^{[ i + 1 ]}} \approx {B}_{{g}_{θ}}^{[ i + 1 ]} = {B}_{{g}_{θ}}^{[ i ]} + \frac{Δ {z}^{[ i + 1 ]} - {B}_{{g}_{θ}}^{[ i ]} Δ {g}_{θ}^{[ i + 1 ]}}{Δ {{z}^{[ i + 1 ]}}^{T} {B}_{{g}_{θ}}^{[ i ]} Δ {g}_{θ}^{[ i + 1 ]}} Δ {z}^{{[ i + 1 ]}^{T}} {B}_{{g}_{θ}}^{[ i ]} \\ where Δ {z}^{[ i + 1 ]} = {z}_{1 : T}^{[ i ]} - {z}_{1 : T}^{[ i ]} and \\ Δ {g}_{θ}^{[ i + 1 ]} = {g}_{θ} ( {z}_{1 : T}^{[ i + 1 ]} ; {x}_{1 : T} ) - {g}_{θ} ( {z}_{1 : T}^{[ i ]} ; {x}_{1 : T} ) . \qquad ( 10 )$$

Initially, one may set B_{g}_{_{θ}}^{[0]}=−I, and the Broyden iterations may be stopped when either the norm of g_{θ}^{[i]} falls below a tolerance ε, or when the maximum number of iterations is reached. This therefore helps avoiding the cubic cost induced by the inverse operation.

A similar idea may be used for the backward pass as well. Specifically, to compute

$$- \frac{\partial 𝓁}{\partial {z}_{1 : T}^{⋆}} ( {J}_{{g}_{θ}}^{- 1} {\vert}_{{z}_{1 : T}^{⋆}} ) ,$$

one may alternatively solve for the linear system:

$$( {J}_{{g}_{θ}}^{T} {\vert}_{{z}_{1 : T}^{⋆}} ) {x}^{T} + {( \frac{\partial 𝓁}{\partial {z}_{1 : T}^{⋆}} )}^{T} = 0 \qquad ( 11 )$$

where the first term (i.e., a vector-Jacobian product) may be efficiently computed via autograd packages (e.g., in PyTorch) for any x, without explicitly writing out the Jacobian matrix. Such linear systems may generally be solved by any indirect methods that leverage fast matrix-vector products. One may also rely on Broyden's method (or in general, other indirect methods would also suffice) to solve for Eq. (11) and directly backpropagate through the equilibrium by Eq. (8) in the backward pass.

A benefit of DEQ may be its extreme memory efficiency. Since any numerical root-finding algorithm may be used for both the forward and backward passes (e.g., Broyden's method), a DEQ may only need to store z_{1:T}* (the equilibrium sequence), x_{1:T} (input-related, layer-independent variables), and ƒ_{θ} for the backward pass. Note that as one may only need the vector-Jacobian product (with dimension N×Td, where N is the minibatch size) in Eq. (11), one may never need to explicitly construct the Jacobian which may otherwise be large on long and high-dimensional sequences (with dimension N×(Td)²). Compared to other deep networks, DEQs may therefore offer a constant-memory alternative that enables models that previously required multiple GPUs and other techniques (e.g., half-precision or gradient checkpointing) to now fit easily into a single GPU.

The above analysis may be independent of the choice of ƒ_{θ}, and the memory benefit may be present regardless of the type of ƒ_{θ}. However, to find the equilibrium in a reliable and efficient manner, generally ƒ_{θ} may need to be stable and constrained. The two following instantiations are examples of stable transformations (the gated activation in TrellisNet and layer normalization in the transformer constrain the output ranges). As both models are drastically different, this illustrate the compatibility of the DEQ approach with all three major families of existing deep sequence networks: transformers, RNNs and temporal convolutional networks (TCNs), but also with any other weight-tied neural networks.

The following describes an embodiment of the DEQ approach for a trellis network. Generally, TrellisNet is a TCN with two modifications. First, a linear transformation of the original input sequence x_{1:T} is injected to the convolutional outputs at all layers. Second, the convolutional kernel weights are tied across the depth of the network (i.e., TrellisNet is a weight-tied TCN). This means one may write TrellisNet with convolutional kernel size k, dilation s, and non-linearity ψ in DEQ-form as

\tilde{x}_{1:T}=Input injection (i. e., linearly transformed inputs by Conv1D(x_{1:T};Wₓ))

ƒ_{θ}(z_{1:T};x_{1:T})=ψ(Conv1D([u_{-(k-1)s:},z_{1:T}];W_{z})+\tilde{x}_{1:T})

where u_{-(k-1)s:} is typically: 1) the last (k−1)s elements of the previous sequence's output (if using history padding); or 2) simply zero-paddings. [⋅,⋅] means concatenation along the temporal dimension. For ψ, LSTM gated activation may be used.

The following describes an embodiment of the DEQ approach for a weight-tied transformer. Instead of using convolutions or recurrence, a transformer network maps the input to a layer into Q (query), K (key) and V (value) and computes the attention score between time tᵢ, tⱼ by [QK^{T}]_{i,j}. This attention score is then normalized via softmax and multiplied with the V sequence to produce the output. Meanwhile, as the transformer is order-invariant, prior works have proposed to inject positional embeddings (PE) to the self-attention operation. Following this design, the universal transformer may “recurrently stack” the transformer's self-attention and transition function block tp through a number of layers.

Accordingly, one may write a weight-tied transformer in DEQ-form as

\tilde{x}_{1:T}=Input injection (i. e., linearly transformed inputs by x_{1:T}Wₓ)

ƒ_{θ}(z_{1:T};x_{1:T})=LN(ϕ(SelfAttention(z_{1:T}W_{QKV}+\tilde{x}_{1:T};PE_{1:T}))))

where W_{QKV}∈ [symbol] ^{d×3d} may produce the Q, K, V for the multi-head self-attention, and LN stands for layer normalization. Note that the above adds input injection \tilde{x}_{1:T} to Q, K, V in addition to the positional embedding and initializes with z_{1:T}^{[0]}=0. A 2-layer position-wise feedforward residual block may be used for ϕ. In addition, a memory-augmented transformer may be used, where [z_{-T′:}*,z_{1:T}] (i.e., with history padding of length T′) and relative positional embedding PE_{-T′:T} may be fed to the self-attention operation.

FIG. 3 illustrates, in the form of a graph 300 setting out input x against output y, a solving for an equilibrium point in 2D for a deep neural network with equilibrium solver (reference numeral 310) and for a weight-tied deep neural network (reference numeral 320) which does not use an equilibrium solver, such as a non-DEQ-based TrellisNet or weight-tied transformer. It is noted that the term ‘equilibrium solver’ refers to a substitution of a stack of layers and the iterative execution of individual layers thereof by the described use of a numerical root-finding algorithm to find the equilibrium point of the corresponding iterative function, with the latter being considered as ‘solving’ the iterative function for the equilibrium. FIG. 3 illustrates steps 330 of the root-finding algorithm, the function g 340 for which the root solution is sought by the root-finding algorithm, and the resulting equilibrium point 350.

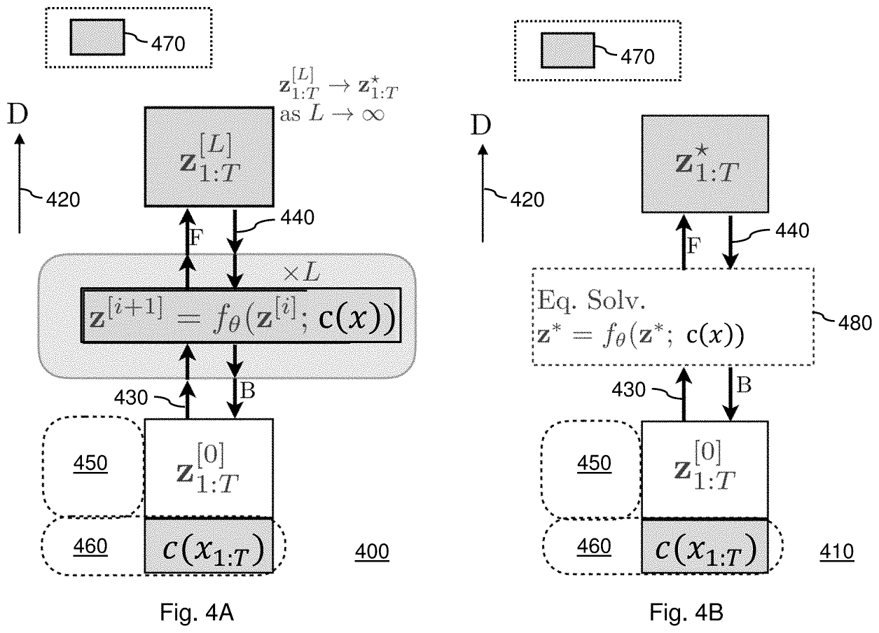

FIG. 4A shows a deep neural network 400 with a stack of layers having mutually shared weights and together defining an iterative function, which again may be a non-DEQ-based TrellisNet or weight-tied transformer. Further shown are the neural network depth 420, the forward propagation direction 430 and the backward propagation direction 440, while denoting with dashed outlines 450, 460 fixed data, in particular with reference numeral 450 the history (or zero) padding (e.g., a previous equilibrium) and with reference numeral 460 the input injection, positional embedding, etc.

Further indicated by grey highlighting is the memory storage 470 which is needed at training time so as to be able to perform the subsequent backward propagation pass. In other words, the grey highlighting indicates variables which need to be kept in memory during and after the forward propagation pass so as to be able to perform the subsequent backward propagation pass. It can be seen that such memory storage may be needed for the input sequence x_{1:T}, the temporary parameters of the iterative function z_{1:T}^{[i+1]}=ƒ_{θ}^{[i]} (z_{1:T}^{[i]},x_{1:T}) for i=0, 1, 2, . . . , L and the output z_{1:T}^{[L]} of the iterative function.

FIG. 4B is similar to FIG. 4A but shows an equilibrium solver 480 substituting the stack of layers of the deep neural network 400 of FIG. 4A. While the equilibrium solver 480 may require some memory storage, e.g., for internal parameters, this memory storage is minor and not needed to be kept for the subsequent backward propagation pass.

The DEQ approach is evaluated on both synthetic stress tests and realistic large-scale language modelling tasks (where complex long-term temporal dependencies are involved) using the two aforementioned instantiations of ƒ_{θ} (trellis network, weight-tied transformer) using the DEQ approach. On both WikiText-103 (which contains >100M words and a vocabulary size of >260K) and the smaller Penn Treebank corpus (where stronger regularizations are needed for conventional deep nets) for word-level language modeling, it is shown that DEQ achieves competitive performance even when compared to state-of-the-art methods (of the same model size, both weight-tied and unweight-tied ones) while using significantly less memory.

Both instantiations of DEQ use Broyden's method to avoid direct computation of the inverse Jacobian, as described earlier. It is noted that the use of DEQ implicitly introduces a new “hyperparameter”: the stopping criterion for Broyden iterations. During training, this tolerance E of forward and backward passes is set to ε=\sqrt{T}·10⁻⁶ and \sqrt{T}·10⁻⁸, respectively. At inference, the tolerance is relaxed to ε=\sqrt{T}·10⁻². For the DEQ-TrellisNet instantiation, the settings described in al are roughly followed. For DEQ-Transformers, the relative positional embedding described in ‘Transformer-XL: Language Modeling with Longer-Term Dependency’ by Zihang Dai is used, with sequences of length 150 at both training and inference on the WikiText-103 dataset. All experiments could run on a single GTX 2080-Ti GPU due to the low memory footprint of DEQ. However, 4 GPUs were used for the WikiText-103 experiments for faster computation.

Evaluations show that the DEQ-approach achieves strong performance on the long-range copy-memory task, as summarized in the following table.

| | Models (Size) | | | |
|---|---|---|---|---|
| | DEQ-Transformer | TCN | LSTM | GRU |
| | (14 K) | (16 K) | (14 K) | (14 K) |
| Copy Memory | 3.5e-6 | 2.7e-5 | 0.0501 | 0.0491 |
| T = 400 Loss | | | | |

Here, TCN refers to https://arxiv.org/abs/1803.01271, LSTM refers to ‘Long short-term memory’ (Hochreiter et al.), GRU refers to https://arxiv.org/abs/1409.1259. The goal of the copy memory task may be considered simple: to explicitly test a sequence model's ability to exactly memorize elements across a long period of time. As shown in the above table, a DEQ-based transformer demonstrates good memory retention over relatively long and low-dimensional sequences (T=400), with even better results than LSTM/GRU.

An issue encountered in prior work that takes a continuous view of deep networks is the challenge of scaling these approaches to real, high-dimensional, large-scale datasets. In the following subsection, the DEQ approach is evaluated on real large-scale language datasets and its effectiveness as a practical sequence model investigated.

Performance on Penn Treebank: following the set of hyperparameters used by [1] for TrellisNet, the DEQ-TrellisNet instantiation is evaluated on word-level language modelling with the PTB corpus. Note that without an explicit notion of “layer”, we do not add auxiliary losses, as was done in [1]. As shown in in the following table, when trained from ‘scratch’, the DEQ-TrellisNet achieves a test perplexity on par with the original deeply supervised TrellisNet. With reference to the table, it is noted that ^{†}the memory footprints are benchmarked on input sequence length 150 and batch size 15, which does not reflect the actual hyperparameters used; the values also do not include memory for word embeddings.

Word-level Language Modelling w/Penn Treebank (PTB)

| | Total | Non- | | |
|---|---|---|---|---|
| | Model | Embedding | Test | |
| Model | Size | Model Size | perplexity | Memory ^{†} |
| Variational LSTM | 66 M | — | 73.4 | — |
| NAS Cell | 54 M | — | 62.4 | — |
| NAS (w/black-box | 24 M | 20 M | 59.7 | — |
| hyperparameter tuner) | | | | |
| AWD-LSTM | 24 M | 20 M | 58.8 | — |
| DARTS architecture | 23 M | 20 M | 55.7 | — |
| search (second order) | | | | |
| 60-layer TrellisNet | 24 M | 20 M | 57.0 | 8.5 GB |
| (w/auxiliary loss, | | | | |
| w/o MoS) | | | | |
| DEQ-TrellisNet | 24 M | 20 M | 57.1 | 1.2 GB |

In the above and elsewhere, ‘the Variational LSTM’ model refers to https://arxiv.org/abs/1512.05287, NAS Cell refers to https://arxiv.org/abs/1611.01578, the following NAS model refers to https://arxiv.org/abs/1707.05589, AWD-LSTM refers to https://arxiv.org/abs1708.02182, DARTS refers to https://arxiv.org/abs/1806.09055, and the 60-layer TrellisNet model refers to https://arxiv.org/abs/1607.06450.

Performance on WikiText-103: On the much larger scale WT103 corpus (about 100× larger than PTB), the DEQ-TrellisNet achieves better test perplexity than the original deep TrellisNet. For the Transformer instantiation, the design of the Transformer-XL model (https://arxiv.org/abs/1901.02860) is followed, which may be considered state-of-the-art in language modelling. Specifically, comparisons are made to a “medium” Transformer-XL model (the largest released model that can fit on a GPU) and a “small” Transformer-XL model, while noting that the largest Transformer-XL model has massive memory requirements (due in part to very large embedding sizes, batch sizes, and sequence lengths, which would not be decreased by a DEQ) and can only be trained on a TPU. In following table, it is shown that the DEQs yield competitive performance on par with state-of-the-art approaches on similar model sizes, while outperforming many prior results, while consuming much less memory during training (discussed below). (^{†}See earlier for more details).

Word-level Language Modelling w/WikiText-103 (WT103)

| | Total Model | | Non-Embedding | | Test | | |
|---|---|---|---|---|---|---|---|
| Model | Size | | Model Size | | perplexity | Memory † | |
| Generic TCN [1] | 150 | M | 34 | M | 45.2 | — | |
| Gated Linear ConvNet | 230 | M | — | | 37.2 | — | |
| AWD-QRNN | 159 | M | 51 | M | 33.0 | 7.1 | GB |
| Relational Memory Core | 195 | M | 60 | M | 31.6 | — | |
| Transformer-XL (X-large, adaptive | >280 | M | 246 | M | 18.7 | 12.0 | GB |
| embed., on TPU) | | | | | | | |
| 70-layer TrellisNet | 180 | M | 45 | M | 29.2 | 24.7 | GB |
| (+ auxiliary loss, etc.) | | | | | | | |
| DEQ-TrellisNet | 180 | M | 45 | M | 29.0 | 3.3 | GB |
| Transformer-XL (medium, not | 170 | M | 44 | M | 24.2 | 8.5 | GB |
| weight-tied 16 layers) | | | | | | | |
| DEQ-Transformer (medium). | 178 | M | 43 | M | 24.5 | 2.7 | GB |
| Transformer-XL (small, not | 139 | M | 4.9 | M | 35.8 | 4.8 | GB |
| weight-tied 4 layers) | | | | | | | |
| Transformer-XL (small, | 138 | M | 4.5 | M | 34.9 | 6.8 | GB |
| weight-tied 16 layers) | | | | | | | |
| DEQ-Transformer (small) | 138 | M | 4.5 | M | 32.4 | 1.1 | GB |

In the above and elsewhere, the Gated Linear ConvNet model refers to http://arxiv.org/abs/1612.08083, AWD-QRNN refers to https://arxiv.org/abs/1803.08240, Relational Memory Core refers to ‘Relational recurrent neural networks’ by Santoro et al., and the 70-layer TrellisNet model refers to https://arxiv.org/abs/1607.06450.

Memory Footprint of DEQ: For conventional deep networks with L layers, the training memory complexity may be O(L) since all intermediate activations are stored for backpropagation. In comparison, DEQs have an O(1) (i.e., constant) memory footprint. The reduced memory consumption is verified in the last column of the above tables, with controlled sequence lengths and batch sizes for fairness. On both instantiations, the DEQ approach leads to an over 80% (up to 88%) reduction in memory consumption by the model (excluding word embeddings, which are orthogonal to the comparison here). Note that the DEQ's memory footprint remains competitive even when compared with baselines that are not weight-tied (over 67% reduction), with similar or better accuracy.

Convergence to Equilibrium: the deep equilibrium model may be considered not to have “layers”. One factor that may affect the computation in DEQs is the number of Broyden iterations in forward/backward passes, where each forward Broyden step evaluates ƒ_{θ} once, and a backward step computes a vector-Jacobian product.

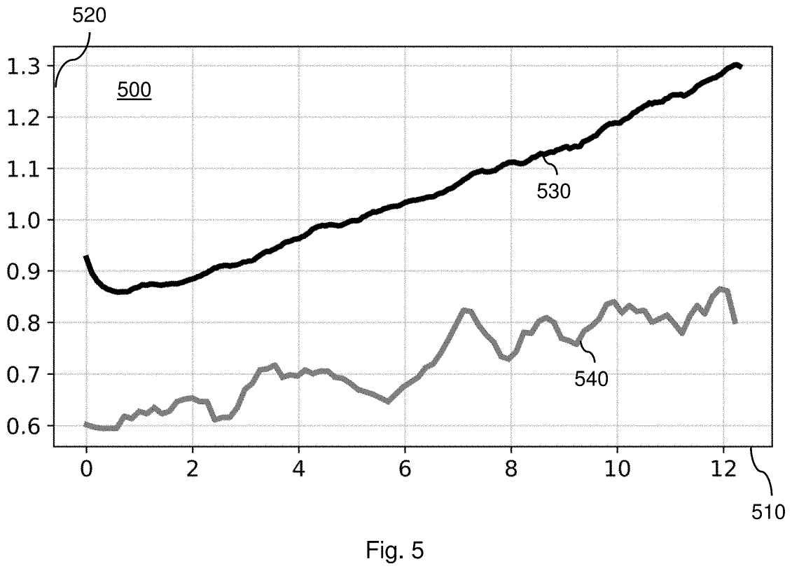

FIG. 5 shows a graph 500 setting out the number of Broyden iterations 520, as computed by

$$\frac{TotalBroydenIterations}{SequenceLength} ,$$

of a deep-equilibrium model (DEQ)-based transformer against the training epoch 510 for both the forward propagation 530 and the backward propagation 540. It is found that in general the number of Broyden iterations gradually increases with training epochs. Meanwhile, the backward propagation 540 may require much fewer iterations than the forward propagation 530, due to the linear system in Eq. 11.

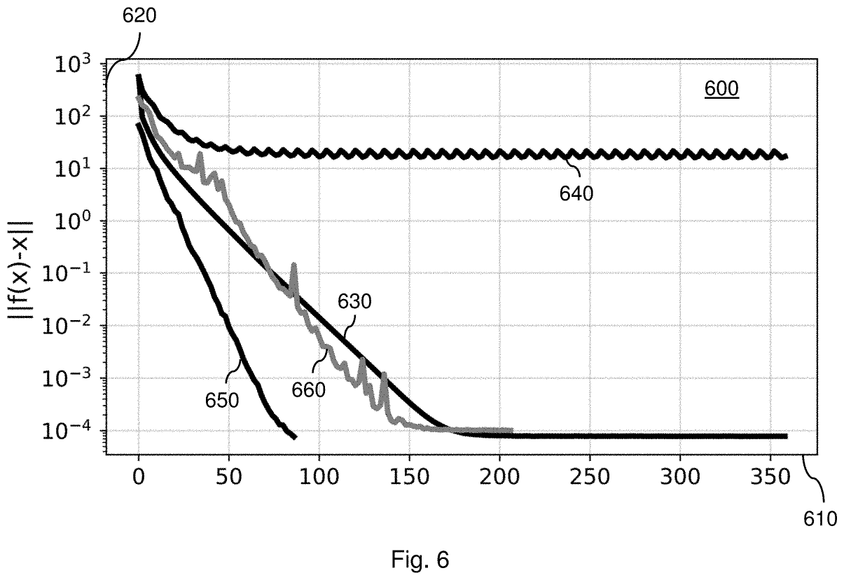

Regarding the convergence to equilibrium, it is found that DEQs may converge to the sequence-level fixed point more, or in many cases much more efficiently than original weight-tied transformers. This is illustrated in FIG. 6, which shows a graph 600 setting out the number of function evaluations 610 against a difference norm 620 for the DEQ-transformer at epoch 1 (reference numeral 650) and at epoch 12 (reference numeral 660) against a weight-tied transformer at epoch 1 (reference numeral 630) and at epoch 12 (reference numeral 640) as reference. It is noted that after 12 epochs, deeply stacked self-attention 640 tends to oscillate around the fixed point, which DEQs converge to stably.

It is further noted that it has been found that stacking multiple DEQs may not create extra representational power over a single DEQ, or in other words, a single DEQ may provide a same representational power as a stacking of multiple DEQs.

FIG. 7 shows a system 700 for controlling or monitoring a physical system using a trained neural network. Such a system 700 may represent a specific example of a system configured to use the trained neural network for inference purposes. The system 700 may comprise an input interface 780 for accessing trained model data 196 representing a trained neural network as may be generated by the system 100 of FIG. 1 or the method 200 of FIG. 2 or as described elsewhere. For example, as also illustrated in FIG. 7, the input interface may be constituted by a data storage interface 780 which may access the trained model data 196 from a data storage 790. In general, the input interface 780 and the data storage 790 may be of a same type as described with reference to FIG. 1 for the input interface 180 and the data storage 190. FIG. 7 further shows the data storage 792 comprising input data 722 to be used as input to the trained neural network to obtain output data representing an inference of the trained neural network. For example, the input data 722 may be or may comprise sensor data obtained from one or more sensors. A specific example, the input data 722 may represent an output of a sensor-based observation of a current state of the physical system, e.g., a sensor measurement, and the trained neural network may provide an inference based on the current state of the physical system, which may in a specific example be an inference relating to a future state of the physical system. In some embodiments, the sensor data as input data 722 may also be received directly from a sensor 20, for example via a sensor interface 720 of via another type of interface instead of being accessed from the data storage 790 via the data storage interface 780.

The system 700 may further comprise a processor subsystem 760 which may be configured to, during operation of the system 700, apply the trained neural network to the input data 722 to obtain output data representing an inference by the trained neural network, wherein said applying may comprise determining the equilibrium point using the substitute for the stack of layers and providing the equilibrium point as a substitute for an output of the stack of layers in the neural network. Such output data may take various forms, and may in some examples be a direct output of the system 700. In other examples, which are also described in the following, the system 700 may output data which is derived from the inference of the trained neural network, instead of directly representing the inference.

It will be appreciated that the same considerations and implementation options apply for the processor subsystem 760 as for the processor subsystem 160 of FIG. 1. It will be further appreciated that the same considerations and implementation options may in general apply to the system 700 as for the system 100 of FIG. 1, unless otherwise noted.

FIG. 7 further shows various optional components of the system 700. For example, in some embodiments, the system 700 may comprise a sensor data interface 720 for directly accessing sensor data 722 acquired by a sensor 20 in an environment 60. The sensor 20 may but does not need to be part of the system 700. The sensor 20 may have any suitable form, such as an image sensor, a lidar sensor, a radar sensor, a pressure sensor, a contain temperature sensor, etc. In some embodiments, the sensor data 722 may sensor measurements of different physical quantities in that it may be obtained from two or more different sensors sensing different physical quantities. The sensor data interface 720 may have any suitable form corresponding in type to the type of sensor, including but not limited to a low-level communication interface, e.g., based on I2C or SPI data communication, or a data storage interface of a type as described above for the data storage interface 780.

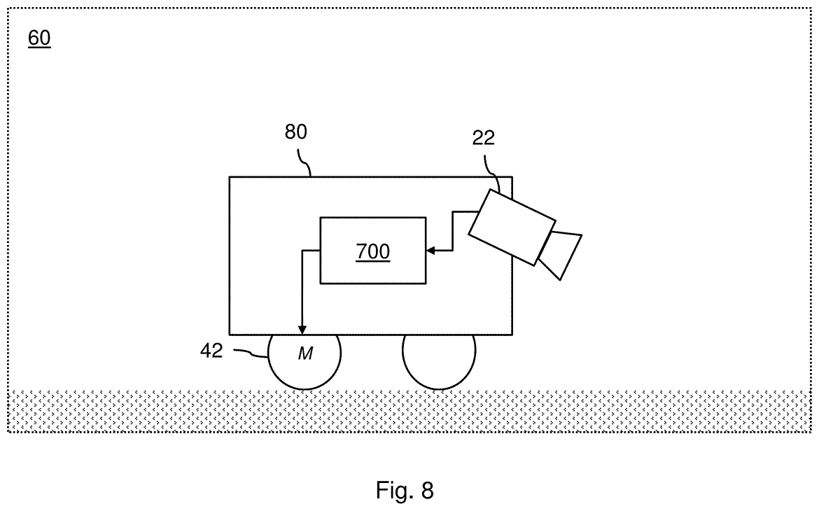

In some embodiments, the system 700 may comprise an actuator interface 740 for providing control data 742 to an actuator 40 in the environment 60. Such control data 742 may be generated by the processor subsystem 760 to control the actuator 40 based on one or more inferences, as may be generated by the trained neural network when applied to the input data 722. For example, the actuator 40 may be an electric, hydraulic, pneumatic, thermal, magnetic and/or mechanical actuator. Specific yet non-limiting examples include electrical motors, electroactive polymers, hydraulic cylinders, piezoelectric actuators, pneumatic actuators, servomechanisms, solenoids, stepper motors, etc. Such type of control is described with reference to FIG. 8 for an (semi-)autonomous vehicle.

In other embodiments (not shown in FIG. 7), the system 700 may comprise an output interface to a rendering device, such as a display, a light source, a loudspeaker, a vibration motor, etc., which may be used to generate a sensory perceptible output signal which may be generated based on one or more inferences by the trained neural network. The sensory perceptible output signal may be directly indicative of the inferences by the trained neural network, but may also represent a derived sensory perceptible output signal, e.g., for use in guidance, navigation or other type of control of the physical system.

In general, each system described in this specification, including but not limited to the system 100 of FIG. 1 and the system 700 of FIG. 7, may be embodied as, or in, a single device or apparatus, such as a workstation or a server. The device may be an embedded device. The device or apparatus may comprise one or more microprocessors which execute appropriate software. For example, the processor subsystem of the respective system may be embodied by a single Central Processing Unit (CPU), but also by a combination or system of such CPUs and/or other types of processing units. The software may have been downloaded and/or stored in a corresponding memory, e.g., a volatile memory such as RAM or a non-volatile memory such as Flash. Alternatively, the processor subsystem of the respective system may be implemented in the device or apparatus in the form of programmable logic, e.g., as a Field-Programmable Gate Array (FPGA). In general, each functional unit of the respective system may be implemented in the form of a circuit. The respective system may also be implemented in a distributed manner, e.g., involving different devices or apparatuses, such as distributed local or cloud-based servers. In some embodiments, the system 700 may be part of vehicle, robot or similar physical entity, and/or may be represent a control system configured to control the physical entity.

FIG. 8 shows an example of the above, in that the system 700 is shown to be a control system of an (semi-)autonomous vehicle 80 operating in an environment 60. The autonomous vehicle 80 may be autonomous in that it may comprise an autonomous driving system or a driving assistant system, with the latter also being referred to as a semiautonomous system. The autonomous vehicle 80 may for example incorporate the system 700 to control the steering and the braking of the autonomous vehicle based on sensor data obtained from a video camera 22 integrated into the vehicle 80. For example, the system 700 may control an electric motor 42 to perform (regenerative) braking in case the autonomous vehicle 80 is expected to collide with a traffic participant. The system 700 may control the steering and/or braking to avoid collision with the traffic participant. For that purpose, the system 700 may infer a current or future state of the vehicle with respect its environment, including the traffic participant, based on the sensor data obtained from the video camera. If the state of the vehicle, e.g., its position relative to the traffic participant, is expected to result in a collision, the system 700 may take corresponding action.

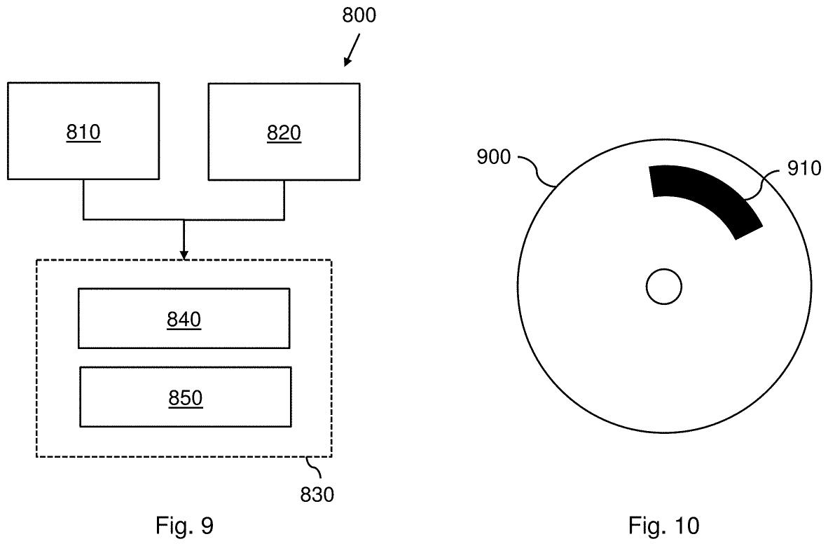

FIG. 9 shows a computer-implemented method 800 for using a trained neural network for inference. The method 800 may correspond to an operation of the system 700 of FIG. 7, but may also be performed using or by any other system, apparatus or device.

The computer-implemented method 800 is shown to comprise, in a step titled “ACCESSING TRAINED NEURAL NETWORK”, accessing 810 a trained neural network as described elsewhere in this specification. The method 800 is further shown to comprise, in a step titled “ACCESSING INPUT DATA”, accessing 820 input data for the trained neural network. The method 800 is further shown to comprise, in a step titled “APPLYING TRAINED NEURAL NETWORK TO INPUT DATA”, applying 830 the trained neural network to the input data to obtain output data representing an inference by the trained neural network. Said applying 830 by the method 800 is shown to comprise, in a step titled “DETERMINING EQUILIBRIUM POINT”, determining 840 the equilibrium point using the substitute for the stack of layers, and in a step titled “PROVIDING EQUILIBRIUM POINT AS SUBSTITUTE FOR OUTPUT OF STACK OF LAYERS”, providing 850 the equilibrium point as a substitute for an output of the stack of layers in the neural network.

It will be appreciated that, in general, the operations or steps of the computer-implemented methods 200 and 800 of respectively FIGS. 2 and 9 may be performed in any suitable order, e.g., consecutively, simultaneously, or a combination thereof, subject to, where applicable, a particular order being necessitated, e.g., by input/output relations.

Each method, algorithm or pseudo-code described in this specification may be implemented on a computer as a computer implemented method, as dedicated hardware, or as a combination of both. As also illustrated in FIG. 10, instructions for the computer, e.g., executable code, may be stored on a computer-readable medium 900, e.g., in the form of a series 910 of machine-readable physical marks and/or as a series of elements having different electrical, e.g., magnetic, or optical properties or values. The executable code may be stored in a transitory or non-transitory manner. Examples of computer-readable mediums include memory devices, optical storage devices, integrated circuits, servers, online software, etc. FIG. 10 shows an optical disc 910. In an alternative embodiment of the computer-readable medium 900, the computer-readable medium may comprise model data 910 defining a trained neural network as described elsewhere in this specification.

Examples, embodiments or optional features, whether indicated as non-limiting or not, are not to be understood as limiting the invention as claimed.

In accordance with an abstract of the specification, it is noted that a neural network may comprise an iterative function (z^{[i+1]}=ƒ(zⁱ, θ, c(x)). Such an iterative function is known in the field of machine learning to be representable by a stack of layers which have mutually shared weights. As described in this specification, this stack of layers may during training be replaced by the use of a numerical root-finding algorithm to find an equilibrium of the iterative function in which a further execution of the iterative function would not substantially further change the output of the iterative function. Effectively, the stack of layers may be replaced by a numerical equilibrium solver. The use of the numerical root-finding algorithm is demonstrated to greatly reduce the memory footprint during training while achieving similar accuracy as state-of-the-art prior art models.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or stages other than those stated in a claim. The article “a” or “an” preceding an element does not exclude the presence of a plurality of such elements. Expressions such as “at least one of” when preceding a list or group of elements represent a selection of all or of any subset of elements from the list or group. For example, the expression, “at least one of A, B, and C” should be understood as including only A, only B, only C, both A and B, both A and C, both B and C, or all of A, B, and C. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A computer-implemented method for training a neural network, comprising:
providing a neural network, wherein the providing of the neural network comprises providing an iterative function as a substitute for a stack of layers of the neural network, wherein respective layers of the stack of layers being substituted have mutually shared weights and receive as input:
an output of a previous layer, or for a first layer of the stack of layers, an initial activation; and
a part of an input of the stack of layers;
accessing training data for the neural network;
iteratively training the neural network using the training data, wherein an iteration of the training comprises a forward propagation part and a backward propagation part, wherein performing the forward propagation part comprises:
determining an equilibrium point of the iterative function at which the iterative function converges to a fixed point, wherein determining the equilibrium point comprises using a numerical root-finding algorithm to find a root solution for the iterative function minus its input, and
providing the equilibrium point as a substitute for an output of the stack of layers in the neural network;
after the training, outputting a trained neural network.

2. The computer-implemented method according to claim 1, wherein performing the backward propagation part comprises:
computing respective partial derivatives of the iterative function with respect to the weights and the part of the input;
computing a gradient at an input of the iterative execution layer for the weights and/or the part of the input as a function of a respective partial derivative and a backpropagated gradient at the output of the iterative execution layer.

3. The computer-implemented method according to claim 2, wherein computing the gradient comprises solving a linear system and computing the gradient as a function of a solution of the linear system.

4. The computer-implemented method according to claim 3, wherein solving the linear system comprises using a fast matrix vector multiplication technique.

5. The computer-implemented method according to claim 3, wherein solving the linear system comprises using an instance of the numerical root-finding algorithm or another type of numerical root-finding algorithm.

6. The computer-implemented method according to claim 1, wherein the numerical root-finding algorithm is a computer-implementation of Newton's method or a computer-implementation of a quasi-Newton method or specifically a computer-implementation of Broyden's method.

7. The computer-implemented method according to claim 1, wherein outputting the trained neural network comprises representing the stack of layers in the trained neural network by at least i) a data representation of a layer of the stack of layers, and ii) a hyperparameter defining a number of layers of the stack of layers at which the output of the stack of layers reaches or to a selected degree approximates the equilibrium point during forward propagation.

8. The computer-implemented method according to claim 1, wherein outputting the trained neural network comprises representing the stack of layers in the trained neural network by at least i) the mutually shared weights, ii) an identifier or a data-representation of the numerical root-finding algorithm, and iii) one or more parameters for using the numerical root-finding algorithm to determine the equilibrium point.

9. The computer-implemented method according to claim 1, wherein outputting the trained neural network comprises representing the stack of layers in the trained neural network by at least i) a data representation of a layer of the stack of layers, and ii) computer-readable instructions defining a convergence check for determining when an output obtained by an iterative execution of the layer reaches or to a selected degree approximates the equilibrium point.

10. The computer-implemented method according to claim 1, wherein the neural network is a feedforward neural network or a recurrent neural network.

11. The computer-implemented method according to claim 1, wherein the training data is time-sequential data, and wherein the neural network is one of a group of: a Trellis network, a transformer network and a temporal convolution network.

12. A computer-implemented method for using a trained neural network for inference, the method comprising:
accessing a trained neural network, wherein the neural network comprises a substitute for a stack of layers of which respective layers have mutually shared weights and receive as input:
an output of a previous layer, or for a first layer of the stack of layers, an initial activation, and
a part of the input of the stack of layers;
wherein the stack of layers forms an iterative function;
wherein the substitute for the stack of layers comprises:
i) the mutually shared weights, ii) an identifier or a data-representation of a numerical root-finding algorithm, and iii) one or more parameters for using the numerical root-finding algorithm to determine an equilibrium point of the iterative function at which the iterative function converges to a fixed point; or
i) a data representation of a layer of the stack of layers, and ii) computer-readable instructions defining a convergence check for determining when an output obtained by an iterative execution of the layer reaches or to a selected degree approximates the equilibrium point;
accessing input data for the trained neural network;
applying the trained neural network to the input data to obtain output data representing an inference by the trained neural network, said applying comprising determining the equilibrium point using the substitute for the stack of layers and providing the equilibrium point as a substitute for an output of the stack of layers in the neural network.

13. A computer-readable medium comprising transitory or non-transitory data representing instructions arranged to cause a processor system to perform the computer-implemented method according to claim 1.

14. A computer-readable medium comprising transitory or non-transitory data representing a trained neural network, wherein the neural network comprises a substitute for a stack of layers of which respective layers have mutually shared weights and receive as input:
an output of a previous layer, or for a first layer of the stack of layers, an initial activation, and
a part of the input of the stack of layers;
wherein the stack of layers forms an iterative function;
wherein the substitute for the stack of layers comprises:
i) the mutually shared weights, ii) an identifier or a data-representation of a numerical root-finding algorithm, and iii) one or more parameters for using the numerical root-finding algorithm to determine an equilibrium point of the iterative function at which the iterative function converges to a fixed point; or
i) a data representation of a layer of the stack of layers, and ii) computer-readable instructions defining a convergence check for determining when an output obtained by an iterative execution of the layer reaches or to a selected degree approximates the equilibrium point.

15. A system for training a neural network, the system comprising:
an input interface for accessing training data for the neural network;
a processor subsystem configured to:
provide a neural network, wherein the providing of the neural network comprises providing an iterative function as a substitute for a stack of layers of the neural network, wherein respective layers of the stack of layers being substituted have mutually shared weights and receive as input:
an output of a previous layer, or for a first layer of the stack of layers, an initial activation, and
a part of the input of the stack of layers;
iteratively train the neural network using the training data, wherein an iteration of the training comprises a forward propagation part and a backward propagation part, wherein performing the forward propagation part comprises:
determining an equilibrium point of the iterative function at which the iterative function converges to a fixed point, wherein determining the equilibrium point comprises using a numerical root-finding algorithm to find a root solution for the iterative function minus its input, and
providing the equilibrium point as a substitute for an output of the stack of layers in the neural network;
an output interface for outputting a trained neural network after the training.

16. A computer-readable medium comprising transitory or non-transitory data representing instructions arranged to cause a processor system to perform the computer-implemented method according to claim 12.
